(19) United States
(12) Patent Application Publication
(10) Pub. No.: US 2011/0256753 A1
(43) Pub. Date: Oct. 20, 2011

(54) ELECTRONIC ASSEMBLY WITH KEYING AND GUIDANCE FEATURES

(75) Inventor: Joseph M. Gulla, Nashua, NH (US)

(73) Assignee: Amphenol Corporation, Wallingford, CT (US)

(21) Appl. No.: 12/761,833

(22) Filed: Apr. 16, 2010

(51) Int. Cl. H01R 13/64

(52) U.S. Cl. 439/378

(57) ABSTRACT

An interconnection system including a two-sided guide pin assembly for aligning connectors on circuit boards. The interconnection system may connect daughter cards disposed on two sides of a backplane. The guide pin assembly includes a first guide pin, a second guide pin facing in a direction opposite to the first guide pin, and at least one separable polarizing member disposed between the guide pins. At least one of the guide pins may be symmetrical and the polarizing member may provide a projection for blocking insertion of the guide pin into a guidance block unless the polarizing member is orientated to align with an orientation member inside the guidance block. Though, one of the guide pins may be asymmetrical to provide a keying feature that only fits into a corresponding guidance block configured with a complementary keying feature.

### BACKGROUND OF INVENTION

1. Field of Invention

Aspects described herein relate generally to electronic assemblies and more specifically to components that guide interconnecting circuit boards into a position such that electrical connectors on the circuit boards align for mating.

2. Discussion of Related Art

Electronic systems are frequently assembled from multiple printed circuit boards. It is generally easier and more cost effective to manufacture a system on several printed circuit boards (“PCBs”) that are connected to one another by electrical connectors than to manufacture a system as a single assembly. A traditional arrangement for interconnecting several PCBs is to have one PCB serve as a backplane. Other PCBs, which are called daughter boards or daughter cards, are then connected through the backplane by electrical connectors. When the backplane contains connectors on two sides, creating an assembly in which daughter boards extend perpendicularly from two sides of the backplane, the backplane may be called a “midplane.”

Frequently, the backplane is mounted in a rack or other frame. The frame has rails on which the daughter cards slide as they are inserted into the system. The rails are aligned with connectors on the backplane so that the connectors on the daughter card are guided toward appropriate connectors on the backplane.

In some instances, the rails do not position the daughter card connectors relative to the backplane connectors accurately enough to ensure that the connectors will mate as the daughter card slides along the rails. It is known to include guidance features on the daughter card and backplane to provide more accurate alignment between the connectors. Known guidance features include metal posts, called guide pins, and corresponding members, called guidance blocks, that have receptacles to receive the guide pins. The pins have a tapered tip and the receptacles have a chamfered opening such that the pin will be centered in the opening of the receptacle as the tapered surface of the pin slides along the chamfered surface.

Guide pins are typically mounted on the backplane and guidance blocks are typically mounted on the daughter cards. These guidance components are mounted in fixed locations relative to the connectors. When the guide pins are centered in the openings of the guidance blocks, the connectors of the daughter card and the backplane should be aligned well enough to accurately mate.

In electronic systems assembled from printed circuit boards, the construction of the backplane may dictate that only certain types of daughter cards be inserted in specific locations, called slots, in the assembly. However, all of the daughter cards for a system will generally have the same shape and may even have the same connector configuration such that any daughter card inserted into any slot will be connected to the backplane. However, appropriate electrical connections may not be formed when a daughter card in inserted into a slot configured for a different daughter car. To avoid daughter cards being plugged into an incorrect slot, features, sometimes called polarizing or keying features, may be attached to the daughter card and backplane. These features are designed to allow a daughter card with a keying feature complementary to those used in a particular slot to be inserted far enough into the slot for connectors on the daughter card to mate with connectors on the backplane. Conversely, daughter cards that have any other type of keying feature are blocked from sliding into the slot far enough for the connectors to mate.

It is known to include keying features on guide pins and guidance blocks.

### SUMMARY OF INVENTION

The inventors have recognized and appreciated that improved guidance and polarizing features would be desirable for use in interconnection systems for electronic devices. Guidance and keying may be provided using a small number of components that may be readily assembled into a relatively large number of keying configurations.

In some aspects, keying may be provided by using a polarizing member that has a keying feature. The polarizing member may be shaped to attach to a printed circuit board assembly in one of multiple orientations to provide multiple keying options from the same component. The polarizing member may be shaped to cooperate with a guidance pin. The guidance pin may serve to attach the polarizing member to the printed circuit board assembly and also to ensure that the keying feature is aligned with a corresponding keying feature on a mating circuit assembly.

The guidance and keying features may be used for single side or double-sided backplanes. When used on double-sided backplanes, the guidance features on one side of the backplane may be used to secure the guidance features on the other. Separable members providing guidance and polarizing features may be used on either one or both sides of the backplane.

In one illustrative embodiment, a guide pin assembly adapted for attachment to a circuit assembly, such as a midplane or backplane in another form, is provided. The guide pin assembly includes a guide pin having a tip and a proximal end, the tip having a tapered portion and the proximal end being adapted for attachment to the circuit assembly. The assembly may also include a polarizing member, which may include a base member having a keying surface adapted for engaging a keying surface on the circuit assembly. The polarizing member may also include a projection extending from the base member at a predetermined position relative to the keying surface.

In another illustrative embodiment, a two-sided guide pin assembly adapted for attachment to a circuit assembly is provided. The guide pin assembly includes a first guide pin having a proximal end and a tip, a polarizing member including a base with a first keying surface and a projection extending from the base; a second guide pin including a skirt portion with a second keying surface and a shaft with a keying region. The tip of the first guide pin faces in an opposite direction to that of the tip of the second guide pin. The polarizing member is disposed between the first guide pin and the second guide pin, with the projection adjacent to and parallel with the first guide pin.

In a further illustrative embodiment, an interconnection system incorporating a guide pin assembly is provided for electrically connecting a first printed circuit board with a second printed circuit board and a third printed circuit board. The interconnection system includes a first guide pin having a first coupling region, a shaft, and a keying region. A first guidance block having a first mating region is adapted to receive at least a portion of the first guide pin. A second guide pin having a second coupling region, a second shaft, and a second keying region is also provided. The second coupling region of the second guide pin is adapted to engage with the first coupling region of the first guide pin. The second keying region has a polygonal surface for engaging a flange surface. A second guidance block has a second mating region that is adapted to receive at least a portion of the second guide pin. The second mating region of the second guidance block complements the keying region on the shaft of the second guide pin. For at least one of the first guide pin and the second guide pin, the keying region is separable from the shaft.

In yet another illustrative embodiment, an interconnection system incorporating a guide pin assembly is provided. The interconnection system connects a first printed circuit board, a second printed circuit board, and a third printed circuit board. The system includes a first guide pin having a first coupling region. A second guide pin faces in a direction opposite to the first guide pin. The second guide pin has a second coupling region that is adapted to engage with the first coupling region of the first guide pin. The second guide pin has a pin keying region. The system also includes a polarizing member with a projection and an opening that is adapted to receive a portion of the second coupling region. The polarizing member and a portion of the second guide pin are adapted to be received by a portion of the first printed circuit board. Attached to the second printed circuit board, a first guidance block includes a first mating region for insertion of at least a portion of the first guide pin. A second guidance block, attached to the third printed circuit board, includes a second mating region for insertion of at least a portion of the second guide pin and the pin keying region.

Other advantages and novel features of the present invention will become apparent from the following detailed description of various non-limiting embodiments of the invention when considered in conjunction with the accompanying figures and from the claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a perspective view of an exemplary connector that may be used with guidance and keying features in accordance with the present invention;

FIG. 2 is a sketch of a portion of a board to board interconnection system, partially cut away, with two connectors in position to mate according to some embodiments of the invention;

FIG. 3 is a sketch of a keying interface on a backplane connector and a corresponding guide pin according to some embodiments of the invention;

FIG. 4 is a sketch of a keying interface on a backplane connector and a guide pin disposed within the interface according to some embodiments of the invention;

FIG. 5 is a sketch of a guidance block and a corresponding orientation member according to some embodiments of the invention;

FIG. 6 is a cross-sectional view of a guide pin mated to a guidance block according to some embodiments of the invention;

FIG. 7 is a cross-sectional view of a guide pin and a guidance block showing undercuts according to some embodiments of the invention;

FIG. 8 is a cross-sectional view taken along the line D-D of FIG. 7 of a guide pin showing an elliptical shaft according to some embodiments of the invention;

FIG. 9 is a partially exploded perspective view of two daughter cards positioned for connection to a circuit assembly, configured as a midplane, according to some embodiments of the invention;

FIG. 10 is a partially exploded perspective view of two daughter cards positioned for connection to a circuit assembly, configured as a midplane, according to some embodiments of the invention;

FIG. 11 is a perspective view of two guide pins and a polarizing member according to some embodiments of the invention;

FIG. 12 is a perspective view of a guide pin and a polarizing member in position for attachment to a backplane according to some embodiments of the invention;

FIG. 13 is another perspective view of a guide pin and a polarizing member in position for attachment to a backplane according to some embodiments of the invention;

FIG. 14 is a perspective view of a guide pin and a polarizing member in position to engage a guidance block on a daughter card according to some embodiments of the invention;

FIG. 15 is an exploded perspective view of a guidance block according to some embodiments of the invention;

FIG. 16 is a perspective view of a mating face of a guidance block according to some embodiments of the invention;

FIG. 17 is an exploded perspective view of a guidance block according to some embodiments of the invention; and

FIG. 18 is a perspective view of a portion of an interconnection system, with a daughter card and midplane cut away, revealing a daughter card connector being guided into position to mate with a backplane connector by a guide pin and a guidance block according to some embodiments of the invention.

### DETAILED DESCRIPTION

Improved guidance and keying features according to embodiments of the invention may be incorporated into many types of electronic devices. These devices may be configured with circuit assemblies to which one or more other circuit assemblies are attached. For example, one or more daughter cards may be connected to a circuit assembly configured as a midplane or other type of backplane.

Regardless of the specific type of circuit assemblies used, an interconnection system of any suitable type may be used to form separable electrical connections between the circuit assemblies. In one aspect, interconnection system may include one or more electrical connectors, guidance features, and/or keying features. The guidance features may aid in aligning the circuit assemblies so that connectors on the circuit assemblies can mate. The keying features may ensure that each circuit assembly appropriately mates with specified other circuit assemblies.

The components of the electric device may be positioned within a support structure, such as a frame or rack. That support structure may include slots as are known in the art for receiving one or more daughter cards to provide coarse alignment of the daughter cards relative to the backplane or other circuit assembly to which the daughter cards are to be connected. For simplicity of illustration, the exemplary embodiments described herein provide interconnection between two or a small number of circuit assemblies and show only one or a small number of connectors for interconnecting each pair of circuit assemblies. Though, it should be appreciated that embodiments may include more connectors and more circuit assemblies. Moreover, other components of the interconnection system and of the electronic device containing the interconnection system might not be expressly described. However, one of skill in the art will recognize that such components may be used with the interconnection system described herein containing improved guidance and polarizing features.

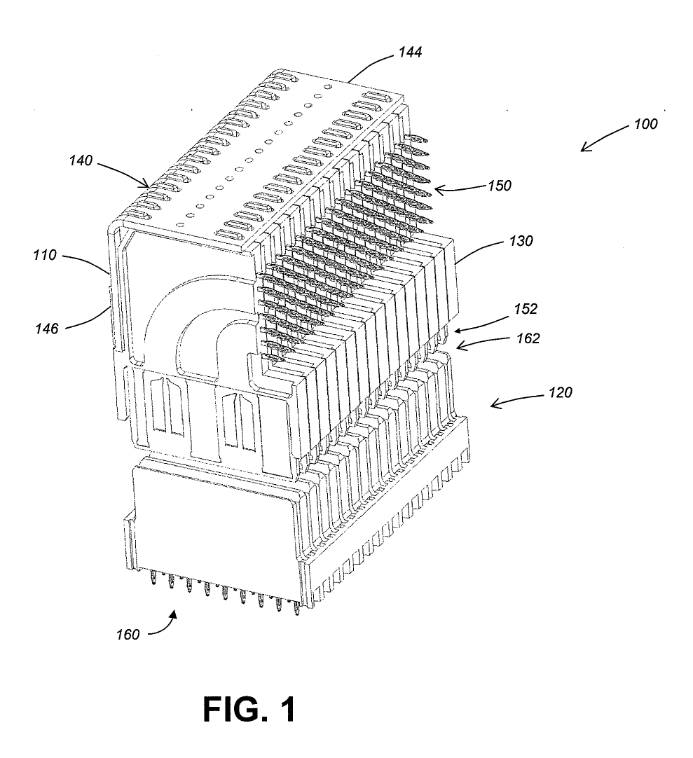

FIG. 1 shows a connector assembly 100 that may be used in an interconnection system according to some embodiments described herein. In the embodiment illustrated, connector assembly 100 is configured as a right angle connector for mating a circuit assembly, such as a midplane or other type of backplane, to another circuit assembly, such as a daughter board. However, the invention is not limited by the intended application and embodiments may be constructed for use as stacking connectors, mezzanine connectors, cable connectors, chip sockets or in any other suitable form. In the pictured embodiment, the connector assembly 100 includes a wafer assembly 110 that may be attached to a daughter board and a backplane connector 120 that may be attached to a backplane.

In the embodiment illustrated, wafer assembly 110 includes a plurality of individual wafers 130 supported by an organizer 140. The organizer 140 may be formed of any suitable material, including metal, a dielectric material or metal coated with a dielectric material. Organizer 140 includes a plurality of openings corresponding to each wafer 130. The organizer 140 supports the wafers in a side-by-side configuration such that they are spaced substantially parallel to one another and form an array.

The array of wafers 130 define a board interface 150 for engaging the daughter board (not shown) and a mating interface 152 for engaging the backplane connector 120 (FIG. 1). In the embodiment illustrated, the board interface is formed of press fit contact tails extending from contact elements within wafer assembly 110. However, any suitable type of contact tails may be used to form the board interface 150. Also, the example shows that mating interface 152 includes pads forming the mating portions of the contact elements within wafer assembly 110. However, pads are just one example of mating portions and the mating interface may have mating portions of any suitable shape.

The organizer 140 may include first and second sections 144 and 146 forming an L-shape. However the organizer 140 may include only one of the first and second sections 144 and 146 or may have any other shape suitable for holding wafers in a desired position. In the embodiment illustrated, organizer 140 is constructed as a single member, but in some embodiments, two or more members may cooperate to form an organizer. In some embodiments, organizer 140 may be omitted and any suitable mechanism may be used to hold the wafers in an assembly.

The wafers 130 may contain projections or other attachment features that engage the organizer 140 via openings by any suitable attachment mechanism, including, for example, a snap engagement, an interference fit or keyed segments. The openings may be disposed in either or both of the first and second sections 144 and 146 of the organizer. Moreover, it is not crucial to the invention that organizer 140 include openings to receive features from wafers 130 because any suitable attachment mechanism may be used, including having projections from organizer 140 engage wafers 130.

Backplane connector 120 also has a board interface 160 for engaging a backplane or other circuit assembly. In this example, board interface 160 has contact tails shaped as press fit contacts as in board interface 150. However, any suitable type of contact tails may be used, and the contact tails of board interface 160 may be the same as those used in board interface 150 or may be different.

Backplane connector 120 also includes a mating interface 162 for mating with wafer assembly 110. Mating interface 162 of backplane connector 120 conforms to the mating interface 152 of wafer assembly 110. As illustrated, mating interface 152 includes multiple blades and mating interface 162 includes multiple slots. When wafer assembly 110 is properly aligned with backplane connector 120, the blades will fit into the slot, forming electrical connections between contact elements within wafer assembly 110 and backplane connector 120.

Though not expressly illustrated in FIG. 1, in use, wafer assembly 110 may be attached along an edge of a daughter card. Backplane connector 120 may be attached to a backplane. The backplane may be attached to a rack, frame, or other support structure. That support structure may include rails or other structures to guide the daughter card toward the backplane. By guiding the daughter card toward the backplane, wafer assembly 110 will tend to be aligned with backplane connector 120. However, a support structure, of a type in widespread use, will provide only coarse alignment of wafer assembly 110 relative to backplane connector 120. Guidance features may be incorporated on the daughter card and the backplane to provide fine alignment between wafer assembly 110 and backplane connector 120.

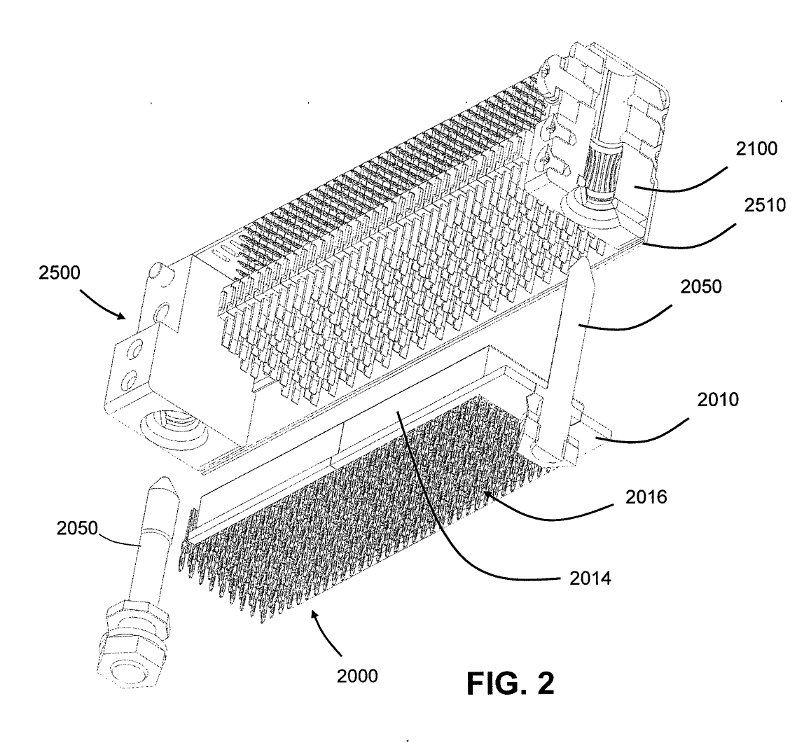

FIG. 2 shows an exemplary interface between two printed circuit boards (printed circuit boards not shown), such as a backplane and a daughter card, that include guidance features. In the embodiment illustrated, conductive members, held within connectors, mate within the interface to provide electrical connections between the boards. The guidance features ensure that the conductive members align. In addition, the interface incorporates polarizing features that limit the types of boards that can form electrical connections through the interface, thereby reducing the risk that an incorrect daughter card will be installed in any slot of an electronic assembly.

FIG. 2 provides an overall perspective, partially cut away, of a daughter card connector 2500 mating with a backplane connector 2000, with various elements in plain view. In use, daughter card connector 2500 may be mounted to a daughter card or other printed circuit board and backplane connector 2000 may be mounted on a backplane or other printed circuit board. In some embodiments, a backplane includes connectors on two sides to enable connections to daughter cards from two sides. However, only a one-sided connection is illustrated in FIG. 2. As shown, backplane connector 2000 includes a backplane connector housing 2014 that further contains numerous backplane contact attachment regions, such as cavities, so that signal and ground conductive elements 2016 may be inserted in any suitable fashion. These conductive elements may be electrically connected, such as through press fit contact tails illustrated in FIG. 2, to conductive traces in the backplane. Conductive elements in daughter card connector 2500, which are here illustrated to be contained within wafers as described above, may mate with the conductive elements in backplane connector 2000. The conductive elements in daughter card connector 2500 may be connected to conductive elements in a daughter card, completing conductive paths between the backplane and the daughter card when the connectors are mated.

Components for attachment to a backplane to provide guidance features are illustrated. In this example, guide pins 2050 are attached to the backplane. Components for attachment to the daughter card to provide complementary guidance features are also included. In this example, guidance blocks 2100 are used. Guidance blocks 2100 are mounted with a predetermined position relative to the contact elements of daughter card connector 2500. Here, guidance blocks 2100 are attached to a support member 2510 that also holds wafers forming the daughter card connector to provide a deterministic position between guidance blocks 2100 and the contact elements. Though, any suitable mechanism may be used to provide a deterministic position.

Guide pins 2050 are mounted with a deterministic position relative to contact elements in backplane connector 2000. In the example illustrated, backplane connector 2000 contains flanges 2010 that each includes a keying interface into which a guide pin 2050 may be inserted. Though, any suitable mechanism to position guide pins 2050 may be used.

As the daughter card connector 2500 is mated with the backplane connector 2000, each guide pin 2050 fits into a guidance block 2100, which is attached to the daughter card connector 2500. As shown, the tips of guide pins 2050 are tapered. Openings in guidance blocks 2100 are chamfered, such that, even if a guide pin 2050 is not centered within an opening, the tip will fit within the chamfered portion of the opening. As the guide pin and guidance block are brought together, the tapered tip of the guide pin will slide along the chamfered surface, tending to center the guide pin within the opening. In this way, guide pins 2050 will be aligned relative to the guidance blocks 2100, which in turn aligns daughter card connector 2500 and backplane connector 2000 for mating.

In this example, the components providing guidance features are keyed, as described below, to also provide polarization. Here, guide pins 2050 contain at least one feature that is asymmetrical in at least one respect. The openings of guidance blocks 2100 also contain asymmetrical features. If an asymmetrical feature of a guidance block is complementary to and aligned with asymmetrical features on a guidance pin, the guidance pin can fit within the opening of the guidance block. Otherwise, the guidance pin will not fit within the opening of the guidance module—blocking daughter card connector 2500 and backplane connector 2000 from mating.

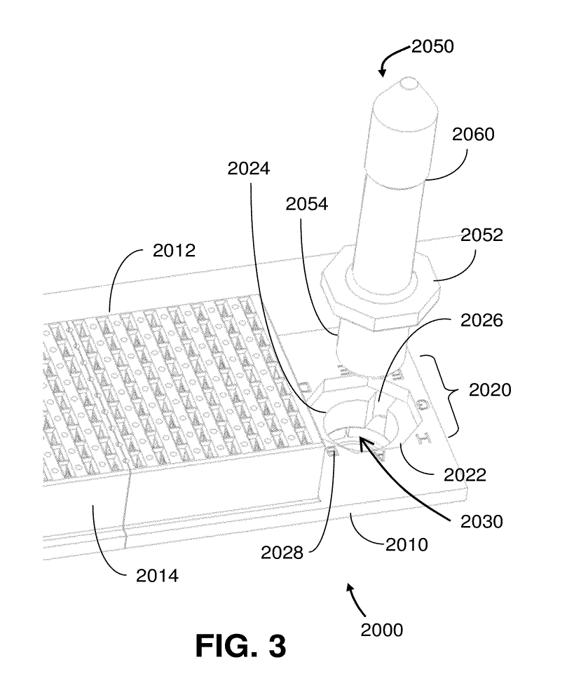

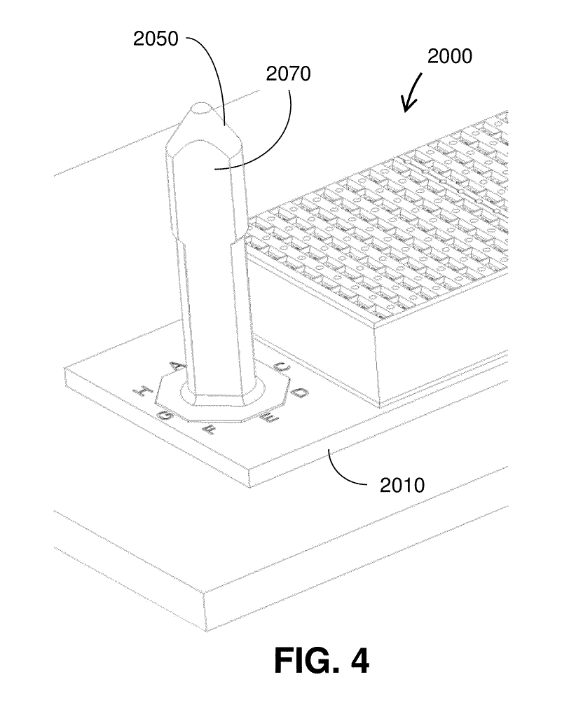

FIGS. 3 and 4 illustrate in greater detail construction and use of a guide pin 2050 according to some embodiments. Guide pin 2050 may provide both a guidance and a polarizing function. To provide polarization, a surface of guide pin 2050 may contain a polarizing feature, such as a projection, recess or other asymmetrical structure. Such a guide pin may be used in connection with a guidance block that has a complementary polarizing feature. If the guidance pin has an orientation that aligns the polarizing feature of the guide pin with the complementary feature on the guidance block, the pin will enter the guidance block. Otherwise, the guide pin will be blocked from entering the guidance block.

In the embodiment illustrated, the flange 2010 is shaped to receive a guidance pin in one of multiple predefined orientations. To provide a controlled positioning of the polarizing feature of the guide pin, backplane connector 2000 may provide a keying interface 2020, which facilitates positioning of guide pin 2050 with an appropriate orientation relative to a guidance block 2100.

In some embodiments, a flange 2010 may extend from the backplane connector housing 2014 and backplane attachment region 2012, including a keying interface 2020 with an opening 2030, which may allow for the guide pin 2050 to be appropriately inserted. In some embodiments, the flange 2010, which includes the keying interface 2020, may be integrally molded together with the backplane connector housing 2014.

In FIGS. 3 and 4, the keying interface 2020 includes an outer keying surface 2022 and an inner circular region 2024 that form a profile that complements the profile of guide pin 2050. As shown in FIG. 3, the guide pin 2050 has a circular portion 2054 and a keying surface 2052 shaped to fit into the interface, as depicted in FIG. 4, in one of a multiple of orientations. It can be appreciated that the keying surface may be polygonal and/or include any suitable shape or dimension and does not have to include equivalent sides, as depicted by the figures. For example, the keying surface may be hexagonal, octagonal, triangular, rectangular, or another appropriate shape.

A hole is depicted that extends through a backplane to which backplane connector 2000 may be mounted. The base of guide pin 2050 may extend through this hole and be secured, such as by a nut threaded onto the base of guide pin 2050. In some embodiments, a second guide pin extending in an opposite direction may be attached to the base of guide pin 2050, both holding guide pin 2050 in place and providing guidance for connectors mounted on an opposite side of the backplane. It should be understood, though, that a through hole in the backplane and backplane connector 2000 is not a necessary requirement for the invention and any suitable attachment mechanism may be used.

In some embodiments, a hole through the backplane may have a notched slot 2026. A corresponding tab on guide pin 2050 (not visible in FIG. 3) may be sized and positioned to fit within this slot. Such a slot may provide an alternative mechanism for positioning guide pin 2050 as is known in the art and may be omitted if positioning of the guide pin is provided by another mechanism, such as outer keying surface 2022.

However, in the embodiment illustrated, both a slot 2026 and outer keying surface 2022 are provided. The slot 2026 may be used to define an orientation of guide pin 2050 at the time the backplane is manufactured, which may be desirable in some cases. Though, in some alternative embodiments, guide pin 2050 may include no projection designed to align with slot 2026 and the orientation of guide pin 2050 may be defined when the guide pin is positioned relative to an outer keying surface 2022 for attachment to a circuit assembly. By providing a connector with a flange as illustrated in FIG. 3, a board with a notched slot 2026 may receive a guide pin as is known in the art or as illustrated in FIG. 3.

To provide a polarizing function, guide pin 2050 has an asymmetrical portion. The guide pin 2050 may be inserted in a variety of keying orientations, given in this example by the polygonal feature. For example, it is possible that the guide pin 2050 be inserted with the asymmetrical portion in a preferred orientation according to how a guidance block 2100 on the daughter card would fit over the pin. For this reason, guide pin 2050 may include a keying region 2070 that serves as a complement to a guidance block profile. In some embodiments, a keying region 2070 may include an asymmetrical portion. In some embodiments, a keying region 2070 may include a flat portion, as depicted in FIG. 4. In some cases, a keying region 2070 may function to ensure that only daughter card connectors configured with the same polarization as is provided by guide pin 2050 may mate with a backplane connector 2000. It should be understood that, though a partially flat guide pin is illustrated, the profile of guide pin 2050 as it complements the profile of the guidance block 2100 may be of any suitable shape. As one example, a protrusion may alternatively or additionally be used to provide a keying region.

Labels 2028 may also be included on the flange 2010 adjacent the keying interface 2020. Labels 2028 may provide for identification of proper orientations within the interface of the guide pin 2050. In embodiments where guide pin 2050 includes no projection sized to fit within a slot 2026, users may change keying positions by removing the guide pin 2050 and then repositioning the pin in the keying interface 2020 with a different orientation. The polygonal shape of keying interface 2020 and keying surface 2022, as depicted in FIGS. 3 and 4 provide eight possible orientations for guide pin 2050. It should be understood that any suitable keying interface profile may be used along with an appropriately shaped guide pin 2050 as polygonal or circular shapes are not intended to be limiting features.

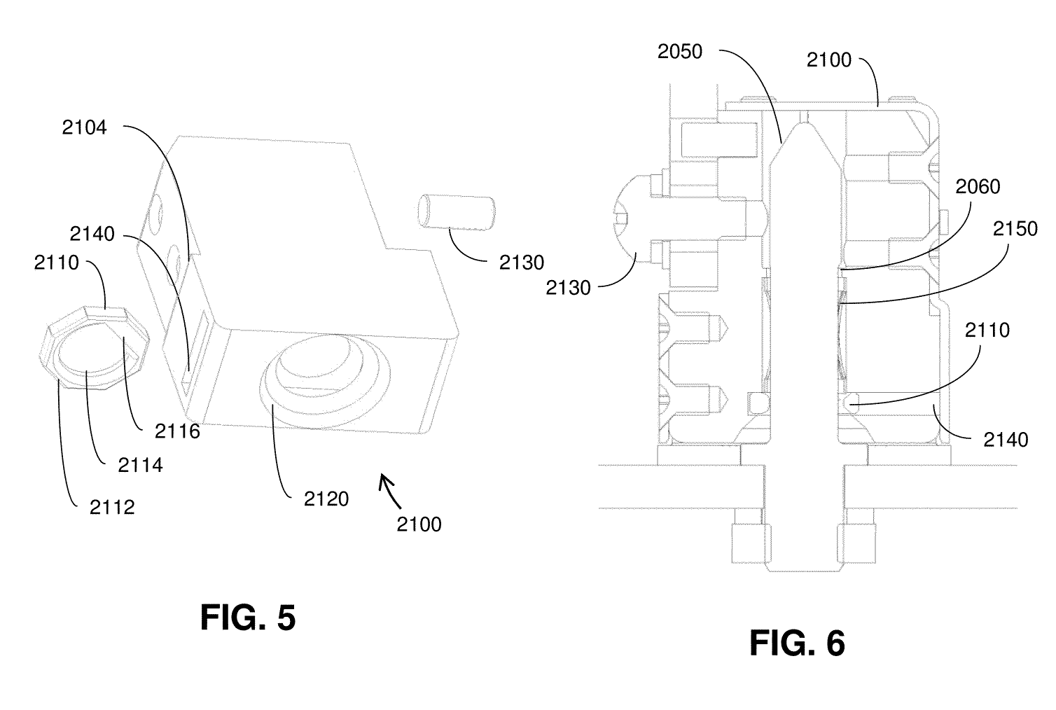

FIG. 5 depicts an embodiment of a guidance block 2100, which may be incorporated into a daughter card connector and may be mounted to a daughter card or other suitable printed circuit board. In some embodiments, a fastener 2130 may be used in order to secure the guidance block 2100 to the daughter card. Fastener 2130 may be a screw or other suitable mechanism. In an embodiment, a guidance block is attached to a daughter card connector. In some embodiments, a stepped surface 2104 may be included on the guidance block 2100 so as to receive a protective covering or attachment member for attachment to a support structure holding a daughter card connector.

Guidance block 2100 is designed to receive a guide pin 2050 so that a daughter card connector and a backplane connector may be aligned for proper mating. The guidance block 2100 may include a tapered region 2120 that can allow for gathering of the guide pin 2050 into a hole in block 2100. An orientation member 2110 may be used to ensure that only a guide pin 2050 with a suitable orientation is received into the block 2100. As illustrated, the inner surface of orientation member 2110 has a shape that complements the outer surface of guide pin 2050. Accordingly, the specific shape of orientation member 2110 may depend on the shape of guide pin 2050.

Orientation member 2110 may be mounted in one or more possible orientations, preferably corresponding to the number of possible orientations of guide pin 2050 when mounted in keying interface 2020. In the embodiment shown in FIG. 5, the orientation member 2110 is shaped as a ring that has an outer polygonal portion 2112, an inner circular portion 2114, and a flat portion 2116. The orientation member 2110 may be inserted within the guidance block 2100 through a slot 2140, allowing for the orientation member 2110 to be placed at a hole location in the block into which guide pin 2050 may be inserted. Slot 2140 may also appropriately constrain the ring-shaped member 2110 in a proper orientation. In various embodiments, slot 2140 has parallel walls to suitably constrain the orientation member 2110. Member 2110 may be placed in any suitable orientation, in this particular embodiment, according to how the flat portion 2116 is positioned. Member 2110 may be oriented to conform with a guide pin in a backplane slot into which a daughter card containing guidance block 2100 is intended to be inserted.

It can be appreciated that the polygonal portion 2112 may include any suitable shape or dimension and does not have to include equivalent sides, as depicted by the figures. For example, the polygonal portion may be hexagonal, octagonal, triangular, rectangular, or other appropriate shape. It can also be appreciated that other aspects of the orientation member, such as the inner circular portion and the flat portion are not required to be shaped as such, and may include any suitable dimension and/or shape. For example, an orientation member may include multiple flat portions or jagged regions that would correspond to an appropriately shaped guide pin.

Because block 2100 may be attached to a daughter card connector in order to facilitate connection between a daughter card and a backplane, when the daughter card connector is mated with the backplane connector, the polygonal portion 2070 of the guide pin 2050 aligns with the flat portion 2116 of the orientation member 2110 according to the desired keying position. In this orientation, guide pin 2050 may pass through orientation member 2110. In other orientations, guide pin 2050 does not fit through orientation member 2110.

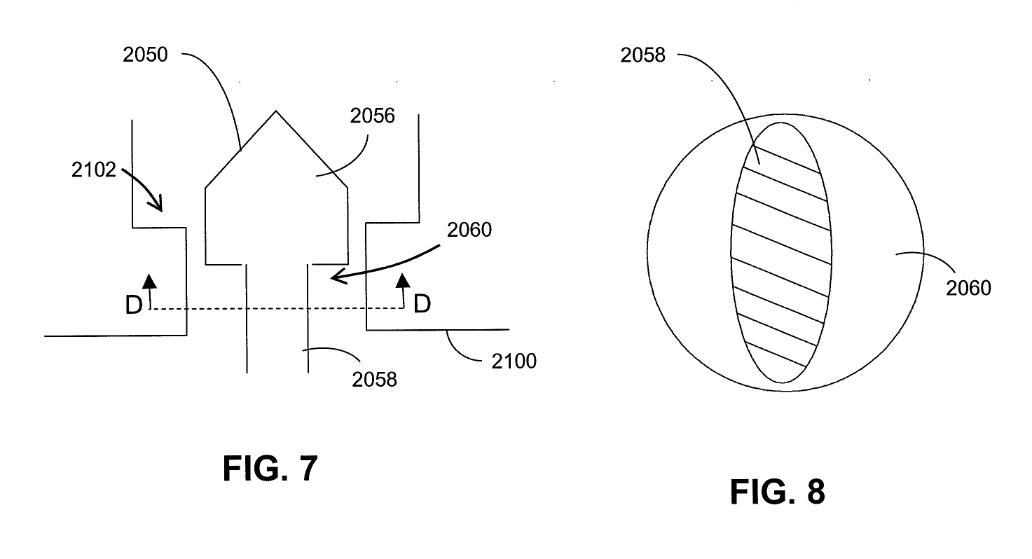

FIG. 6 shows a cross-section view of a guide pin 2050 inserted within guidance block 2100. To facilitate float, an undercut 2060 may be incorporated in the guide pin profile so that appropriate float may occur once the connectors are mated. In various embodiments, either or both of the guide pin 2050 and guidance block 2100 has an undercut region such as undercut regions 2060 or 2102, shown with more emphasis in FIG. 7, that allows for movement or “float” of the pin shaft 2058 within the guidance block 2100 once the pin and block are mated. This float may be allowed in one direction orthogonal to the shaft 2058 of guide pin 2050. In the embodiment shown, the undercut region 2102 within guidance block 2100 may be present along one cross-section, yet in a transverse cross-section, a constraining wall may take the place of the undercut region, not allowing for float in a perpendicular direction.

In some embodiments, translation in one direction, as permitted from the undercut regions 2060 and 2102, allows for float of the printed circuit board and the backplane to occur in a direction in which compliant contacts within backplane connector 2000 can accommodate float, but precludes relative movement in a direction that could overstress and therefore damage compliant contacts. Float could be used with rail locks for ruggedization or for pressing of components against a cold wall. Though, float may be provided for any other purpose or, in some embodiments, features to provide float may be omitted.

In some embodiments, the guide pin 2050 may have a substantially elliptical cross-section, as depicted in FIG. 8, allowing translation to occur in a first direction parallel to the backplane substantially more than translation in a second direction which is also parallel to the backplane, but perpendicular to the first direction. In some embodiments, an undercut region 2102 within guidance block 2100 is substantially elliptical, allowing for movement laterally in a first direction parallel to the backplane substantially more than in a second direction which is perpendicular to the first direction, yet movement in the second direction is not completely constrained. FIGS. 7 and 8 show an example of an elliptical pin shaft 2058 and a circular upper tip 2056, which allows float to occur once the tip 2056 moves into an opening 2102 where shaft 2058 provides space for translation to be permitted.

In various embodiments, a safety ground spring is included within the block 2100 in order to provide grounding of the pin 2050 as it is installed. In this respect, risk of damage to a printed circuit board from electrostatic discharge (ESD) may be reduced. The spring and pin may be connected to grounds on the daughter board and backplane, making a path to dissipate static electricity when mated.

The components providing guidance features may be made of any suitable materials, including materials as are known in the art for manufacturing components of an interconnection system. For example, guide pin 2050 may be molded plastic, metal, or any other rigid material. In other embodiments, the guide pin 2050 may include a metal post, overmolded with plastic or other suitable coating. Features may be cut into the guide pins or the guide pins may be molded or cast with the desired shape.

Guidance block 2100 may be formed of any suitable material. In some embodiments, the guidance block 2100 may be molded plastic. In other embodiments, the orientation member 2110 may be formed out of the same material as the guidance block 2110 or may be a different material than the guidance block 2110, such as metal or another rigid material.

Connection interfaces for electrically connecting printed circuit boards may include alternative configurations. In some cases, a backplane may contain backplane connectors on two sides, allowing daughter cards to be connected to either side of the backplane. To facilitate connection of daughter card connectors to backplane connectors on opposing sides of a backplane, pairs of guide pins may be included with the interface of the backplane connector. Guide pins of the pair may face in opposite directions from one another to provide a two-sided guide pin assembly.

When used in pairs, the guidance pins may be shaped as described above to provide guidance and polarization. Each daughter card may include a guidance block, as described above, to align with one of the guide pins. As discussed above, the guidance blocks may be mounted to a daughter card.

In some embodiments, each of the guide pins may be oriented relative to a backplane connector on one side of a backplane using techniques as described above. For example, each guide pin may be mounted within a flange surface on a backplane connector. Keying features may be formed in the guide pins.

Though, in some embodiments, a separable polarizing member may be associated with one or both of the guide pins providing a keying interface and/or keying features.

The polarizing member may include a feature, a projection in the illustrated embodiment, that conforms with an appropriate region of a guidance block of a daughter card connector. The polarizing member also may have a shape that facilitates mounting relative to a backplane connector in one of a number of predefined orientations. In embodiments in which a separable polarizing member is used with a guide pin, that guide pin may be circularly symmetrical such that the orientation of the guide pin does not provide a polarizing feature.

In a two-sided guide pin assembly, guide pins may include separable polarizing members regardless of the directions in which they face. However, in some embodiments, only one of the guide pins may be associated with a polarizing member. If keying is desired for the other guide pin of the two-sided guide pin assembly, the second guide pin may include a shaft having a keying region, or other keying feature integral with the shaft of the guide pin that mates with an appropriate region of a different guidance block corresponding to another daughter card connector.

In a two-sided guide pin assembly, the guide pins may be attached to a backplane in any suitable way. In some embodiments, the guide pins may connect to each other such that additional components to attach the guide pins to the backplane are not required. For example, the guide pins that are adapted for use in a two-sided guide pin assembly may include coupling members that allow for pairs of guide pins to be attached to one another.

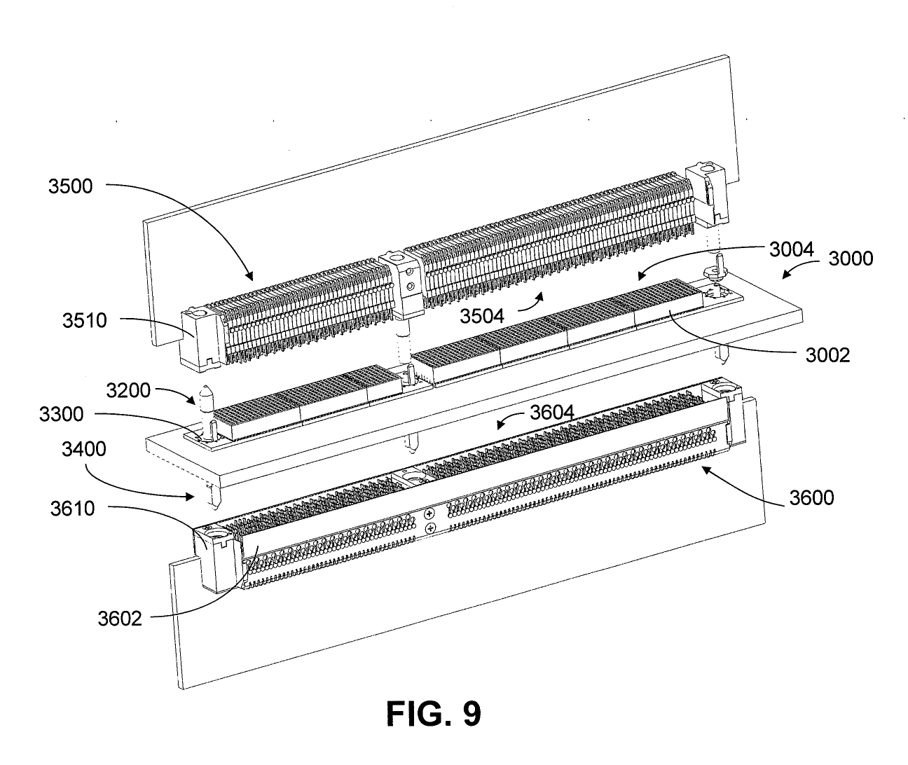

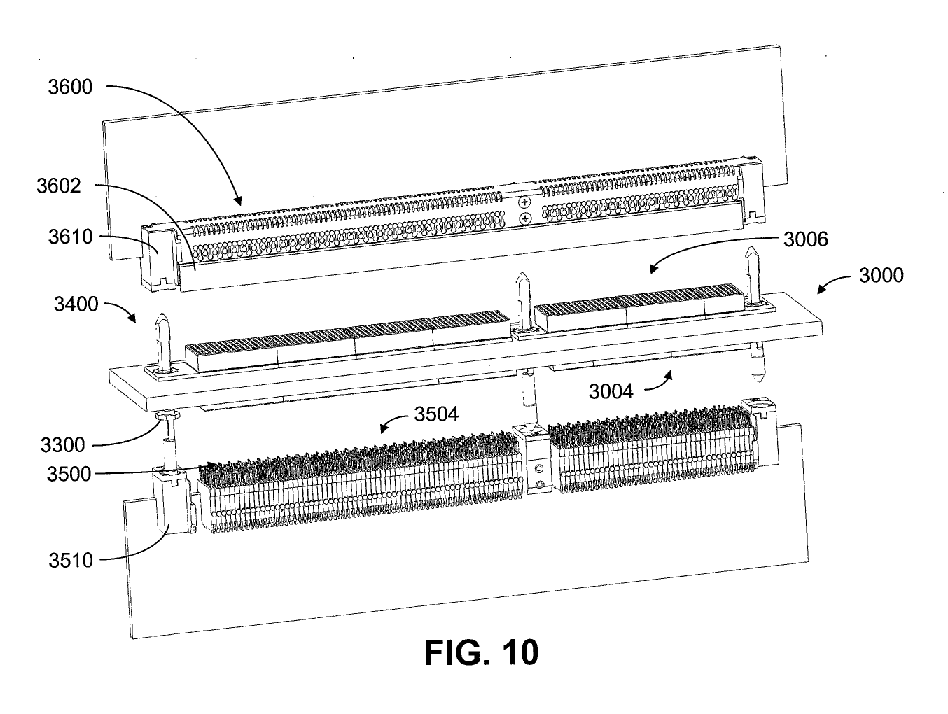

FIGS. 9 and 10 depict an illustrative embodiment of a backplane connector 3000 and two daughter card connectors 3500 and 3600 disposed on opposing sides of the backplane. In some embodiments, daughter card connectors 3500 and 3600 may each be mounted to a daughter card or other printed circuit board and backplane connector 3000 may be mounted on a backplane or other printed circuit board or other circuit assembly.

FIG. 9 shows one perspective view of daughter card connectors 3500 and 3600 prior to mating with backplane connector 3000, while FIG. 10 shows another perspective view from a different angle. Backplane connector 3000 includes a backplane connector housing 3002 providing a backplane mating interface 3004. Within mating interface 3004, conductive elements within backplane connector 3000 are positioned for mating with corresponding conductive elements in daughter card connectors 3500.

As shown, backplane mating interface 3004 conforms with daughter card mating interface 3504 so that first daughter card connector 3500 may be connected with backplane plane connector 3000. Similarly, daughter card mating interface 3604 may be appropriately connected with a corresponding backplane mating interface 3006 of backplane connector 3000. Daughter card housing 3602 provides support for conductive elements such that mating contact portions of the conductive elements are held within daughter card mating interface 3604.

Conductive elements in the daughter card and backplane connectors may be electrically connected, such as through press fit contact tails that are connected to conductive traces located in the backplane. When the daughter card and backplane connectors are mated, conductive elements in daughter card connectors 3500 and 3600 may mate with the conductive elements in backplane connector 3000, completing conductive paths between the backplane and the daughter card when the connectors are mated.

Also depicted in FIGS. 9 and 10, backplane connector 3000 includes three guide pin assemblies, with each of the guide pin assemblies having a pair of guide pins and a polarizing member. In the embodiment illustrated, each of the guide pin assemblies is the same. Though, in some embodiments, different keying may be provided on different guide pin assemblies or different techniques may be used to construct different guide pin assemblies attached to the same printed circuit board.

In the embodiment illustrated, in one guide pin assembly, first guide pin 3200 and second guide pin 3400 face in opposite directions from one another and polarizing features of different constructions are used in connection with first guide pin 3200 and second guide pin 3400. First guide pin 3200 is associated with polarizing member 3300, the combination of which corresponds to the interface provided by guidance block 3510 of first daughter card connector 3500. The shaft of second guide pin 3400 includes a keying region that corresponds with the interface provided by guidance block 3610 of second daughter card connector 3600.

Guidance blocks may be mounted to a daughter card or other suitable printed circuit board in any appropriate manner. For example, guidance blocks may be mounted with a fastener, an adhesive, or may be integrally attached with a printed circuit board. The guidance block may be directly attached to the printed circuit board or may be attached to a connector or support member for a connector, which is in turn connected to a printed circuit board.

It should be understood that not all features of the interconnection system described herein (e.g., backplane connector and daughter card connectors) are explicitly shown in the figures for simplicity. Indeed, portions of the printed circuit boards such as housing portions or other regions of the connectors (e.g., wafers) may not be shown. Features not shown may be formed in a conventional way or in any suitable way, whether now known or hereafter developed.

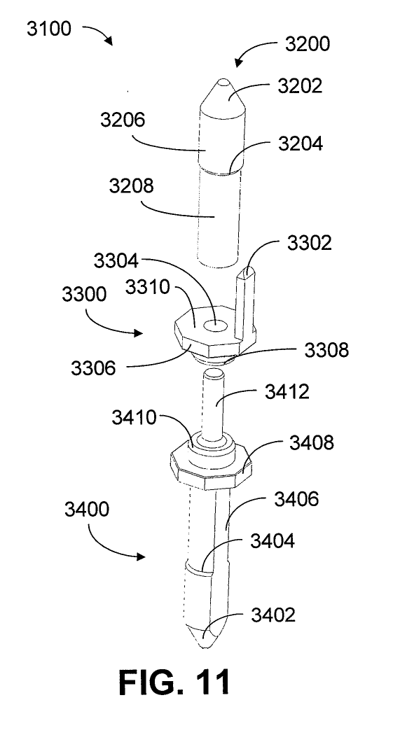

A two-sided guide pin assembly 3100 in accordance with some embodiments is depicted in FIG. 11. Guide pin assembly 3100 allows polarizing features on each of the guide pins to be independently positioned. Such a guide pin assembly may be used to independently specify keying on opposite sides of a two-sided printed circuit board, while providing a simple attachment mechanism for the guide pin assembly.

As illustrated, guide pin assembly 3100 includes first guide pin 3200, polarizing member 3300, and second guide pin 3400. Guide pins and polarizing members may be formed out of any appropriate material. In some embodiments, guide pins and/or polarizing members may be molded plastic, metal, or any other rigid material. In other embodiments, guide pins and/or polarizing members may include a metal post, plastic, and/or a suitable coating.

FIG. 11 illustrates first guide pin 3200 including a tapered region 3202 for providing positioning tolerance when the guide pin is mated with a guidance block. To facilitate connection of a guide pin into a guidance block when the guide pin is inserted into the guidance block, tapered region 3202 contacts a complementary surface in the guidance block so as to appropriately direct the guide pin into the guidance block.

As depicted in this embodiment, an undercut 3204 separating upper region 3206 and lower region 3208 may also be provided for facilitating float within a corresponding guidance block once connectors are mated. As described above for undercut regions (e.g., FIGS. 7 and 8), such float may occur in one direction orthogonal to a shaft of the guide pin 3200. In some embodiments, in accordance with the structure of a corresponding guidance block, a constraining wall may prevent float in a different direction.

FIG. 11 also illustrates a separable polarizing member 3300 associated with first guide pin 3200 having a base member 3310. The polarizing member 3300 includes a polarizing feature, here projection 3302 that extends from the base member 3310. The projection blocks guide pin 3200 from fully engaging with a guidance block unless the guidance block has a corresponding complementary feature to receive projection 3302 when guide pin 3200 is inserted in the guidance block.

In some embodiments, and as shown in FIG. 11, an opening 3304 may be incorporated in a polarizing member 3300 which may provide an opening through which coupling member 3412, which in the illustrated embodiment is integral with a guide pin 3400, may pass to connect with a coupling member of guide pin 3200. It can be appreciated that coupling members may be any suitable structure or orientation. For example, one coupling member can be a threaded hole corresponding to another coupling member that is a threaded bolt. Coupling members may also be provided separate or attached to guide pins. The base member 3310 of polarizing member 3300 may also include a keying surface 3306 for facilitating incorporation of the guide pin assembly 3100 with a backplane connector in one of multiple predefined orientations. A protruding member 3308 may also be included in a polarizing member to provide for centering polarizing member 3300 in an opening of a printed circuit board, connector housing or other substrate.

In some embodiments, guide pin assembly 3100 may further include a second guide pin 3400 that faces in a direction opposite to first guide pin 3200. Second guide pin 3400 includes a tapered region 3402 that provides tolerance in positioning when the guide pin is mated with a guidance block. Similarly to that discussed above for tapered region 3202, upon insertion of the opposite guide pin into another guidance block, tapered region 3402 may contact a complementary surface in the guidance block so as to appropriately direct the guide pin into the guidance block.

An undercut 3404 separating upper and lower regions of the guide pin may also be included (e.g., for facilitating float within a corresponding guidance block). In some embodiments, the second guide pin 3400 includes a keying region 3406 that may serve as a complement to a guidance block profile when connecting a backplane and a printed circuit board (e.g., daughter card connector). In one embodiment, a keying region 3406 may include an asymmetrical portion. In another embodiment, a keying region 3406 may include a flat portion, as illustrated in FIG. 11.

Similarly to the keying surface 3306 of the polarizing member 3300, a keying surface 3408 may also be included in the second guide pin 3400. Keying surface 3408 may provide for the guide pin assembly 3100 to appropriately interface with a backplane connector.

Second guide pin 3400 may also include a protruding member 3410. In some embodiments, the protruding member 3410 centers second guide pin 3400 in an opening in a printed circuit board, connector housing or other substrate.

In some embodiments, as described above, coupling member 3412 may be integral the second guide pin 3400 and may complement a coupling member (not shown) of the first guide pin 3200 so that the guide pins 3200 and 3400 may be suitably attached. Coupling member 3412 of the second guide pin 3400 may be threaded similar to a threaded bolt, and a coupling member of the first guide pin 3200 may be appropriately threaded (e.g., a threaded hole) to receive the coupling member 3412 of the second guide pin 3400. As a result, one threaded coupling member may be suitably screwed into another complementary threaded coupling member as a polarizing member is located in between guide pins.

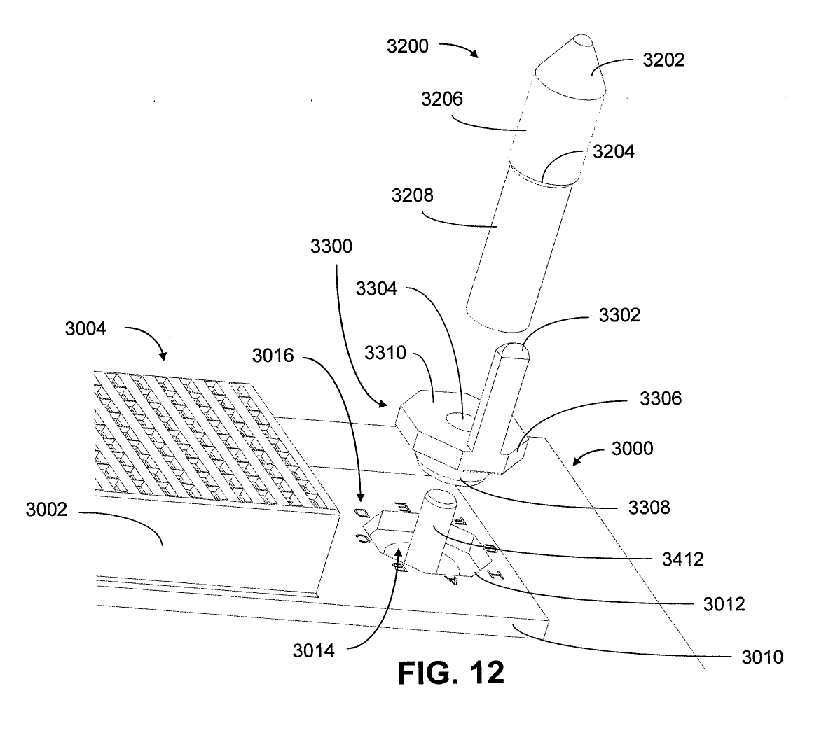

FIG. 12 depicts an illustrative embodiment of a guide pin assembly that is being attached to a backplane connector 3000. Backplane connector 3000 includes backplane connector housing 3002 and mating interface region 3004. Mating interface region 3004 positions conductive elements within backplane connector 3000 where they can mate with mating contacts of a daughter card connector. Backplane connector 3000 also includes a flange 3010 for receiving a guide pin assembly.

In some embodiments, and as shown in FIG. 12, flange 3010 includes a keying surface 3012 and an opening 3014. The keying surface 3012 has a complementary shape relative to the keying surface 3306 of polarizing member 3300. The opening 3014 provides space for the protruding member 3308 of polarizing member 3300 to be placed within flange 3010. As shown, polarizing member 3300 includes an opening 3304 where coupling member 3412 of a second guide pin is connected with a coupling member of the first guide pin 3200.

Similarly to that described above in FIG. 3, labels 3016 may be included on the flange 3010 adjacent the keying surface 3012 to identify various possible orientations for interfacing the polarizing member 3300 with the flange 3010. Users may change keying positions by removing the polarizing member 3300 and repositioning the polarizing member in the polygonal interface at a different orientation. It can be appreciated that the keying surface 3012 of the flange 3010 and the keying surface 3306 of the polarizing member 3300 may be of any suitable shape, as polygonal or circular shapes are not intended to be limiting features.

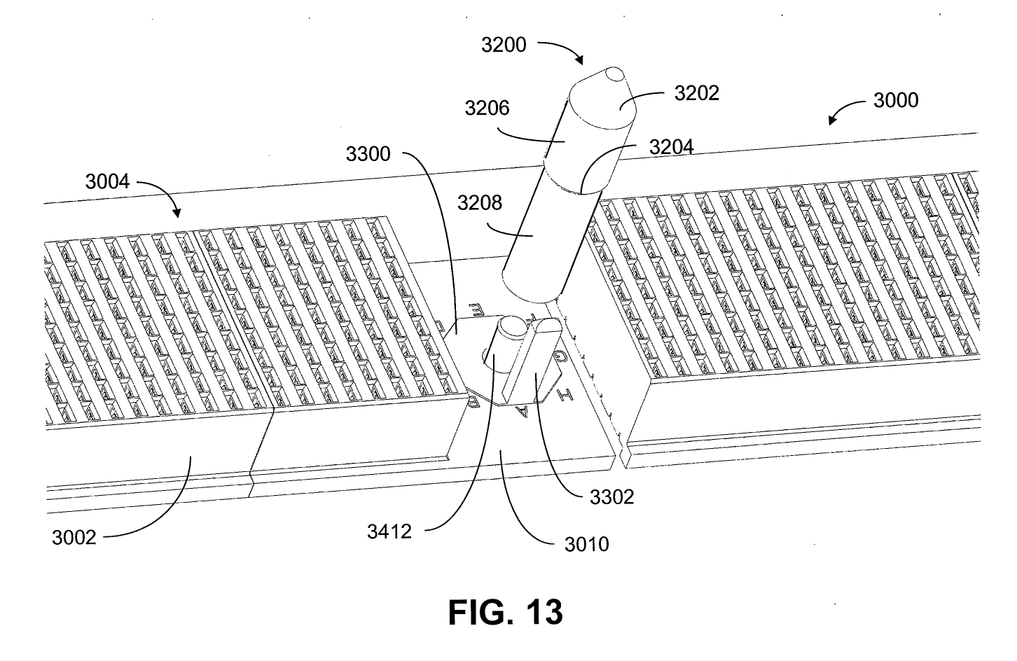

FIG. 13 depicts polarizing member 3300 disposed within an opening in flange 3010 of the backplane connector 3000. As described, the keying surface of the flange 3010 and the keying surface of the polarizing member 3300 are complementary to one another for the polarizing member 3300 to appropriately fit in the flange 3010. As the polarizing member 3300 is suitably disposed in the flange 3010 and the coupling member 3412 of the second guide pin is appropriately positioned to receive the coupling member of the first guide pin 3200, the first guide pin may be attached to the backplane.

Though, it should be appreciated that it is not a requirement that a guide pin with a separable polarizing member be attached to a printed circuit boar using a coupling member that is integral with another guide pin. In some embodiments, a coupling member that is not integral with a second guide pin, may still provide a mechanism of attachment for a first guide pin 3200 to the backplane 3000. In some embodiments, a coupling element may be a fastener. For example, a threaded fastener may be provided for attachment of a first and/or second guide pin to the backplane, with the first and second guide pin both having coupling members (not shown) that are complementary to receive a suitable threaded fastener. Accordingly, for some embodiments, a fastener may be separate from the second guide pin, and the second guide pin may include a coupling member that is shaped as an opening, similar to that depicted in the figures with respect to the first guide pin.

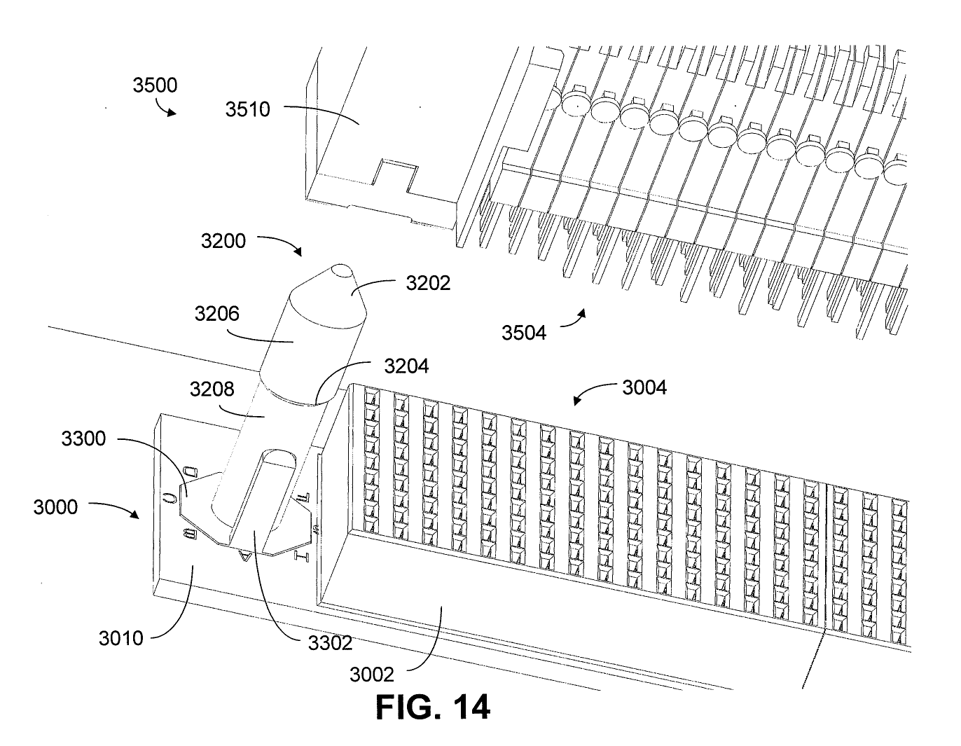

FIG. 14 illustrates an embodiment of the first guide pin 3200 attached at the backplane. As described previously, polarizing member 3300 is disposed within the flange 3010 and the first and second guide pins are mated through attachment of respective coupling members. As described previously, a mating element may be attached to or separate from the second guide pin.

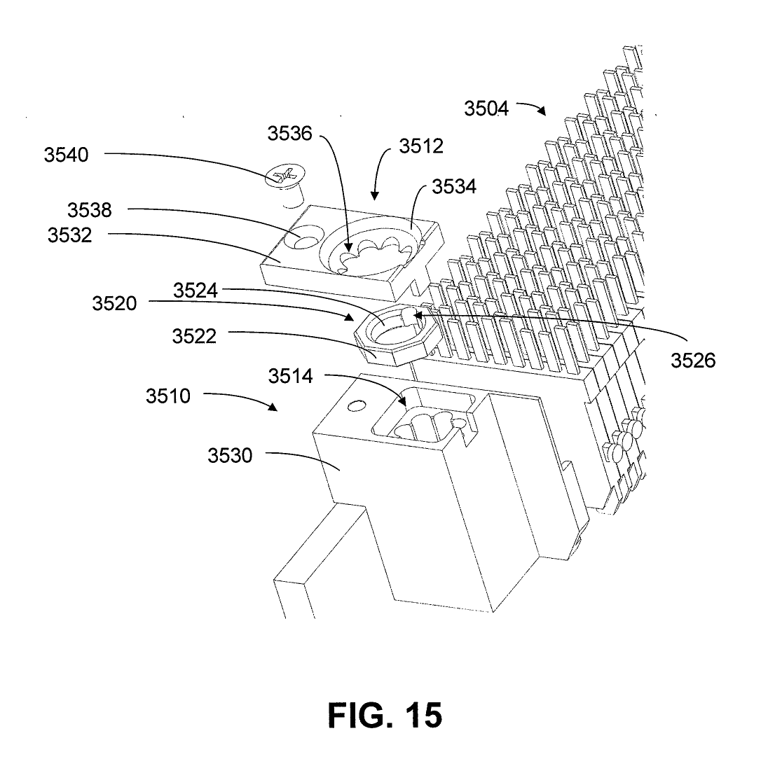

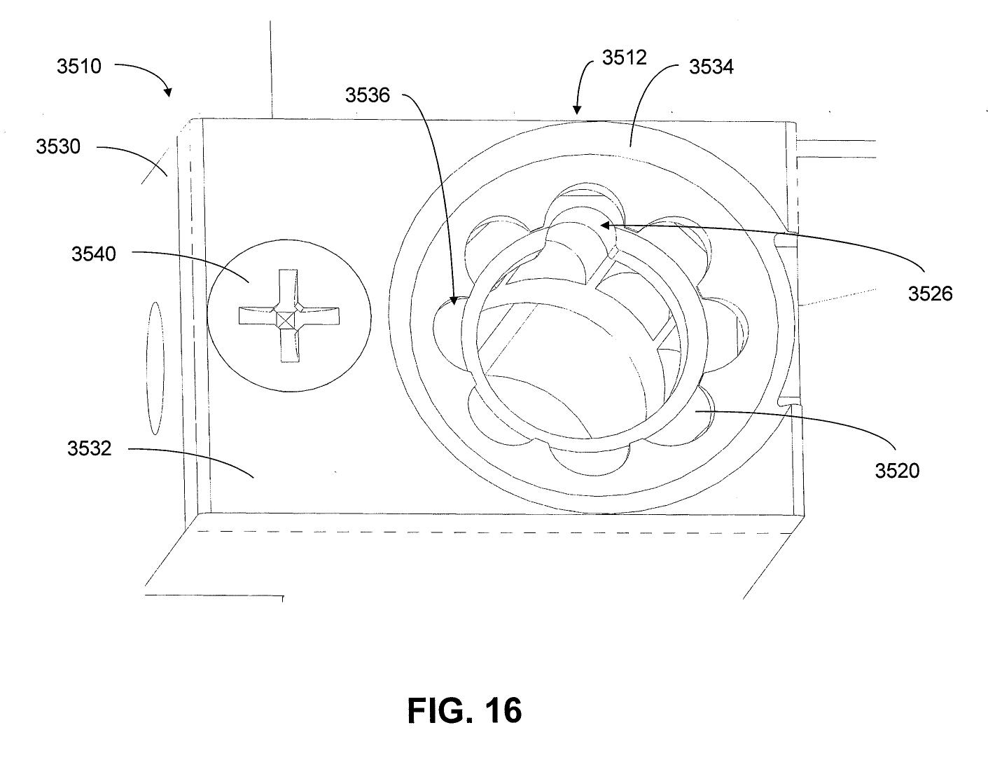

First daughter card connector 3500 is shown prior to being mated with backplane connector 3000. To aid in alignment of the connectors and to provide keying, first daughter card connector 3500 includes a guidance block 3510. Guidance block 3510 has a mating region, shown in FIGS. 15 and 16, that may be configured to conform with the shape of first guide pin 3200 and the projection 3302 of polarizing member 3300, for any of the possible orientations of polarizing member 3300. Ion this way, the mating region of guidance block 3510, in combination of first guide pin 3200 and polarizing member projection 3302, provide a keying function. In some embodiments, and as described above in FIGS. 5 and 6, though not required, a separable orientation member within guidance block 3510 may be used to ensure that only a projection with a particular orientation is received into the guidance block.

FIGS. 15 and 16 show an illustrative embodiment of the mating region 3512 of a guidance block 3510. As shown, various elements may be included in the mating region 3512 and the guidance block 3510 such as guidance block body portion 3530 and guidance block face portion 3532.

Guidance block 3510 may include an orientation member 3520 that may be placed within the guidance block and, accordingly, may facilitate keying of a corresponding guide pin into the guidance block. In the embodiment illustrated, orientation member 3520 may be held within a cavity in guidance block body portion 3530 when guidance block face portion 3532 is secured, such as by fastener 3540. In some embodiments, orientation member 3520 may be directly placed in guidance block 3510 through an insertion opening 3514 which may be provided in the first guidance block body portion 3530. Alternatively, an orientation member 3520 may be inserted into a guidance block 3510 through a slot, as described above for FIG. 5, or in any other suitable way.

In the example shown in FIG. 15, orientation member 3520 includes an outer keying surface 3522 that is suitable for constraining the orientation member 3520 within the guidance block 3510. The inner surface 3524 of orientation member 3520 may be dimensioned so as to allow for the shaft of a guide pin to be inserted into the guidance block. In addition, the inner surface of orientation member 3520 may include a cut out portion 3526 that allows for a projection of a polarizing member associated with the guide pin to be inserted into the guidance block. It can be appreciated that the cut out portion 3526 may be appropriately shaped so as to complement a corresponding projection such that the guide pin, when coupled to a polarizing member with a projection, can only be fully inserted into guidance block 5310 when the polarizing member has an orientation that positions the projection to align with cut out portion 3526. Conversely, the guidance pin will be blocked from entering guidance block 5310 if the guide pin assembly and guidance block do not have the same keying orientation.

In one embodiment, guidance block face portion 3532 may include an opening that has a tapered region 3534 to facilitate centering a guide pin within the opening. In the embodiment illustrated, that opening may have multiple cut out portions 3536, each one shaped to receive a projection of a guide pin. Each of the multiple cut out portions 3536 may correspond with one of the alternative possible orientations of the orientation member 3520. In this way, a single guidance block face portion 3532 may be used regardless of orientation of orientation member 3520. For example, the multiple cut out portions 3536 of mating region 3512 provide for adjustments where orientation member 3520 may be rotated so that cut out portion 3526 is placed in a position that differs from the position illustrated in FIG. 16. Accordingly, whether the projection of a guide pin may be inserted into a guidance block will depend on how the cut out 3526 of orientation member 3520 is positioned.

In some embodiments, guidance block face portion 3532 may also include an attachment region 3538 for a fastener 3540 to suitably attach first and second guidance block attachment portions together. In FIG. 15, members of the guidance block are not yet assembled. However, FIG. 16 shows a perspective view of the mating region 3512 where members of the guidance block 3510 are assembled. Orientation member 3520 is appropriately placed in the guidance block. Guidance block face portion 3532 and guidance block body portion 3530 are attached via fastener 3540. As depicted, cut out portion 3526 of the orientation member 3520 is aligned with one of the cut out portions 3536 of the guidance block face portion 3532 such that a projection associated with a guide pin may suitably fit into the guidance block 3510.

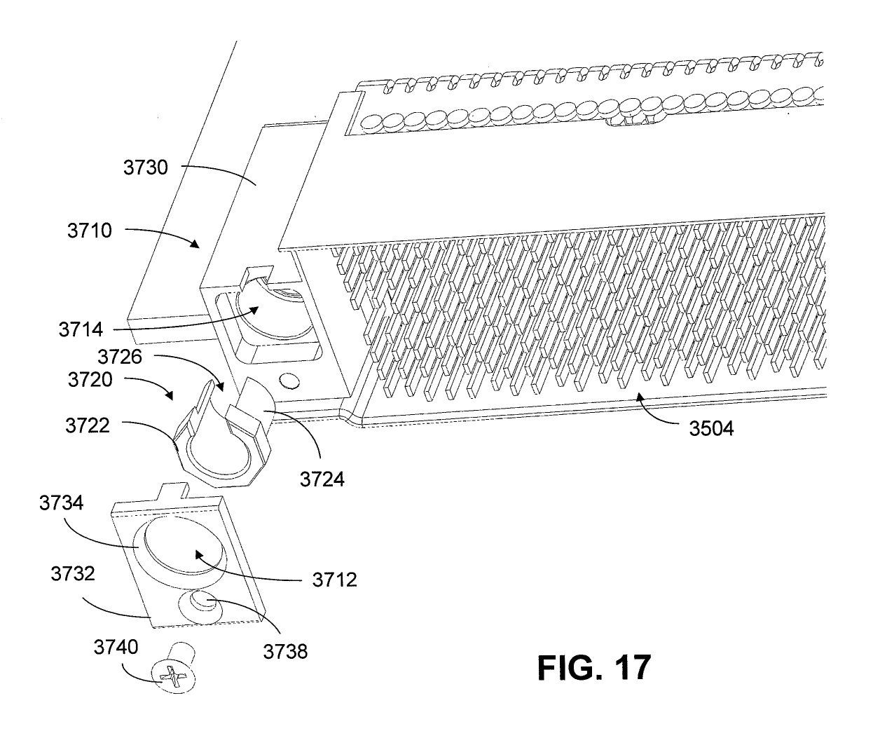

FIG. 17 depicts another illustrative embodiment of elements in a guidance block 3710 that make up a mating region 3712. Similarly to that depicted above for FIGS. 15 and 16, guidance block 3710 may include guidance block body portion 3730 and guidance block face portion 3732. However, in the embodiment illustrated, guidance block face portion 3732 includes a generally smooth, circular chamfered opening to urge a guide pin towards a center of the opening as it is inserted into guidance block 3710.

Guidance block 3710 may include an orientation member 3720 that may be placed within the first guidance block attachment portion 3730 in order to facilitate keying of a corresponding guide pin into the guidance block. Orientation member 3720 may include a keying surface 3722 that has a geometry which provides for suitable placement of the orientation member 3720 within the guidance block 3710 in one of multiple predefined orientations. In the embodiment illustrated, orientation member 3720 has a chamfered, circular opening that aligns with the chamfered opening of guidance block face portion 3732. Such a configuration may facilitate a smooth insertion of a guidance pin into guidance block 3710.

In some embodiments, orientation member 3720 may be partially tubular and may include a surface 3724 that facilitates positioning of orientation member 3720 into the first guidance block attachment portion 3730. Orientation member 3720 may include a cut out portion 3726 that provides a space so that a projection from a polarizing member of a guide pin may be inserted into the guidance block 3710. It should be understood that a cut out portion 3726 is appropriately shaped so as to complement a corresponding projection from a guide pin assembly. As illustrated, cut out portion 3726 may also extend into a surface 3724 of an orientation member 3720 so as to provide space for elements of a guide pin to be inserted into the guidance block 3710. Orientation member 3720 is shaped, however, to prevent a projection from a polarizing member of a guide pin from being inserted into the guidance block 3710 when the projection does not align with cut out portion 3726.

In some embodiments, orientation member 3720 is placed directly into the guidance block body portion 3730 through an insertion opening 3714. Accordingly, the added structure of surface 3724 may provide increased support so that orientation member 3720 may be suitably maintained within the first guidance block attachment portion 3730. Such additional support may be desirable to ensure that orientation member 3720 does not deform or move under forces asserted on the orientation member 3720 when a guidance pin with a projection keyed other than with an orientation that matches the keying of orientation member 3720. Further, when a guidance pin with a projection keyed other than with an orientation that matches the keying of orientation member 3720 is inserted into the guidance block, surface 3724 may prevent the projection from gouging or otherwise damaging the surface of guidance block body portion 3730.

In some embodiments, second guidance block attachment portion 3732 of guidance block 3710 may include an opening that has a tapered region 3734 as a portion of the mating region 3712. As described above, tapered region 3734 may facilitate the insertion of a guide pin into the guidance block 3710.

Second guidance block face portion 3732 may include an attachment region 3738 for a fastener 3740 to suitably attach first and second guidance block attachment portions together. FIG. 17 depicts elements of the guidance block not having been assembled yet. Upon assembly, orientation member 3720 is placed in guidance block body portion 3730 and guidance block face portion 3732 is placed over orientation member 3720. Guidance block body portion 3730 and guidance block face portion 3732 are then attached via fastener 3740. Once guidance block 3710 is assembled, cut out portion 3726 of the orientation member 3720 is appropriately oriented such that a projection associated with a corresponding guide pin may be suitably inserted into the guidance block 3710.

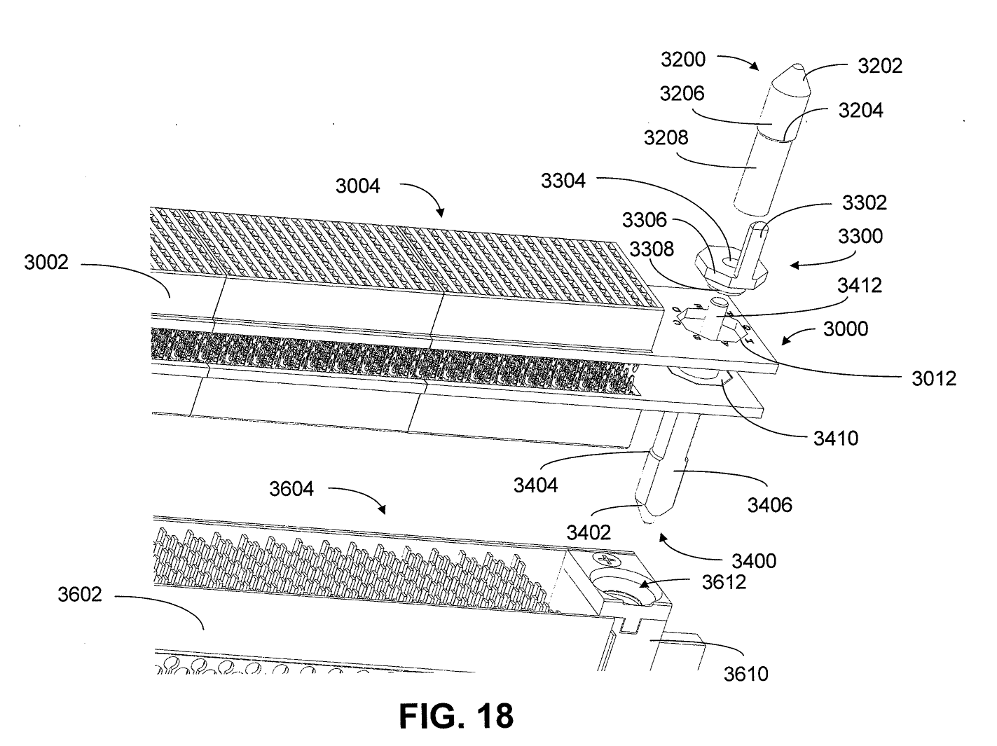

FIG. 18 depicts an embodiment showing a guide pin assembly associated with a backplane connector 3000 and a second daughter card connector 3600. The guide pin assembly includes a first guide pin 3200, a polarizing member 3300, and a second guide pin 3400. Second guide pin 3400 includes a projection 3406 having a surface that corresponds with mating region 3612 of the guidance block 3610 of second daughter card connector 3600. Thus, when backplane connector 3000 and second daughter card connector 3600 are connected, second guide pin 3400 is inserted into the guidance block 3610 of second daughter card connector 3600 and corresponding attachment regions are also connected together.

In addition, though not shown, upon connection between backplane connector 3000 and first daughter card connector 3500, first guide pin 3200 is inserted into a corresponding guidance block in the first daughter card connector. Thus, first guide pin 3200 is attached to polarizing member 3300 via coupling member 3412 where polarizing member 3300 includes a projection 3302 that corresponds to a mating region of a guidance block attached to the first daughter card connector. The corresponding guidance block includes a mating region that complements the tip of guide pin 3200 and projection 3302 upon connection of the daughter card connector and attachment regions of the backplane connector.

As illustrated in various embodiments provided above and in the figures, connection interfaces for electrically connecting printed circuit boards together are described herein. In some cases, two daughter card connectors may be connected to opposite sides of a backplane connector. The backplane connector may include guide pins that face toward corresponding guidance blocks of daughter card connectors upon connection of daughter card(s) and a backplane.

Upon connection of guide pins to the backplane connector, the guide pins may face in directions that are opposite to one another. A polarizing member may be associated with one or both of the guide pins. The polarizing member may include a projection that acts as a keying region and engages with a guidance block of a daughter card connector. The other guide pin may have a shaft that includes a keying region for engaging with a guidance block of another daughter card connector. Guide pins and projections may limit the types of printed circuit boards that can form electrical connections, reducing the risk that printed circuit boards will be installed incorrectly in an electronic assembly.

The guide pins may have coupling regions that include coupling members that complement one another, which serve to provide attachment for the guide pins.

While particular embodiments have been chosen to illustrate the invention, it will be understood by those skilled in the art that various changes and modifications can be made therein without departing from the scope of the invention as defined in the appended claims.

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having thus described several aspects of at least one embodiment of this invention, it is to be appreciated various alterations, modifications, and improvements will readily occur to those skilled in the art.

As one example, different features were discussed above in connection with different embodiments of the invention. These features may be used alone or in combination.

Such alterations, modifications, and improvements are intended to be part of this disclosure, and are intended to be within the spirit and scope of the invention. Accordingly, the foregoing description and drawings are by way of example only.

What is claimed is:

1. A guide pin assembly adapted for attachment to a circuit assembly, the guide pin assembly comprising:
a guide pin having a tip and a proximal end, the tip having a tapered portion and the proximal end being adapted for attachment to the circuit assembly; and
a polarizing member, the polarizing member comprising:
a base member having a keying surface adapted for engaging a keying surface on the circuit assembly; and
a projection extending from the base member at a predetermined position relative to the keying surface.

2. The guide pin assembly of claim 1, further comprising a coupling member for coupling the guide pin with the circuit assembly.

3. The guide pin assembly of claim 2, further comprising an opening in the base member for the coupling member to pass through.

4. The guide pin assembly of claim 1, wherein the polarizing member engages with the proximal end of the guide pin.

5. The guide pin assembly of claim 1, further comprising a second polarizing member disposed on an opposite end of the guide pin.

6. The guide pin assembly of claim 1, wherein the guide pin includes a rounded shaft.

7. The guide pin assembly of claim 1, wherein the keying surface of the base member includes a polygonal surface.

8. The guide pin assembly of claim 2, wherein the polarizing member includes an opening for receiving a portion of the coupling member.

9. The guide pin assembly of claim 1, further comprising a flange that is adapted to engage with the base member of the polarizing member.

10. The guide pin assembly of claim 1, further comprising a guidance block having a mating region that complements a portion of the guide pin and a portion of the projection that extends from the base member.

11. A two-sided guide pin assembly adapted for attachment to a circuit assembly, the guide pin assembly comprising:
a first guide pin having a proximal end and a tip;
a polarizing member comprising a base with a first keying surface and a projection extending from the base;
a second guide pin comprising a skirt portion with a second keying surface and a shaft with a keying region; and
wherein the tip of the first guide pin faces in an opposite direction to that of the tip of the second guide pin and the polarizing member is disposed between the first guide pin and the second guide pin, with the projection adjacent to and parallel with the first guide pin.

12. The guide pin assembly of claim 11, wherein the first guide pin includes a first coupling region and the second guide pin includes a second coupling region, and the coupling regions being adapted to couple the first guide pin and the second guide pin together.

13. The guide pin assembly of claim 12, wherein the first coupling region comprises a threaded hole.

14. The guide pin assembly of claim 12, wherein the second coupling region comprises a threaded bolt.

15. The guide pin assembly of claim 11, wherein the first keying surface includes a polygonal surface.

16. The guide pin assembly of claim 11, wherein the second keying surface includes a polygonal surface.

17. The guide pin assembly of claim 11, wherein the first guide pin comprises a rounded shaft.

18. The guide pin assembly of claim 11, wherein the polarizing member includes a protruding member for engaging a portion of the second guide pin.

19. The guide pin assembly of claim 11, wherein the second guide pin includes a protruding member for engaging a portion of the polarizing member.

20. An interconnection system incorporating a guide pin assembly, the interconnection system for electrically connecting a first printed circuit board with a second printed circuit board and a third printed circuit board, the interconnection system comprising:
a first guide pin having a first coupling region, a shaft, and a keying region;
a first guidance block having a first mating region that is adapted to receive at least a portion of the first guide pin;
a second guide pin having a second coupling region, a second shaft, and a second keying region, the second coupling region of the second guide pin adapted to engage with the first coupling region of the first guide pin, and the second keying region having a keying surface for engaging a flange surface;
a second guidance block having a second mating region that is adapted to receive at least a portion of the second guide pin, wherein the second mating region of the second guidance block complements the keying region on the shaft of the second guide pin; and
wherein for at least one of the first guide pin and the second guide pin, the projection is separable from the shaft.

21. The interconnection system of claim 20, wherein the first coupling region comprises a threaded hole.

22. The interconnection system of claim 20, wherein the second coupling region comprises a threaded bolt.

23. The interconnection system of claim 20, wherein the keying region of the first guide pin includes a polarizing member that is separable from the shaft.

24. The interconnection system of claim 23, wherein the polarizing member includes a projection for insertion into at least a portion of the first guidance block.

25. The interconnection system of claim 20, wherein the first guide pin includes a rounded shaft.

26. The interconnection system of claim 20, wherein the keying surface includes a polygonal surface.

27. An interconnection system incorporating a guide pin assembly, the interconnection system for connecting a first printed circuit board, a second printed circuit board, and a third printed circuit board, the system comprising:
a first guide pin having a first coupling region;
a second guide pin facing in a direction opposite to the first guide pin, the second guide pin having a second coupling region that is adapted to engage with the first coupling region of the first guide pin, and the second guide pin having a pin keying region;
a polarizing member having a projection, the polarizing member including an opening that is adapted to receive a portion of the second coupling region, wherein the polarizing member and a portion of the second guide pin are adapted to be received by a portion of the first printed circuit board;
a first guidance block having a first mating region for insertion of at least a portion of the first guide pin, the first guidance block being attached to the second printed circuit board; and
a second guidance block having a second mating region for insertion of at least a portion of the second guide pin and the pin keying region, the second guidance block being attached to the third printed circuit board.

28. The interconnection system of claim 27, wherein the polarizing member includes a keying surface for engaging a flange having a complementary keying surface.

29. The interconnection system of claim 27, wherein the second guide pin includes a keying surface for engaging a flange having a complementary keying surface.
